(19) United States
(12) Patent Application Publication
(10) Pub. No.: US 2026/0061682 A1
(43) Pub. Date: Mar. 5, 2026

(54) DISTRIBUTED COMPRESSION TOOLING FOR A COMPUTER PERIPHERAL DEVICE

(71) Applicant: Logitech Europe S.A., Lausanne (CH)

(72) Inventors: Meng Li, Suzhou City (CN); Fangming Peng, Suzhou City (CN)

(21) Appl. No.: 18/820,023

(22) Filed: Aug. 29, 2024

(51) Int. Cl. B29C 45/57; B29C 45/00; B29C 45/40; B29C 45/56; B29L 31/34

(52) U.S. Cl. CPC B29C 45/572; B29C 45/0025; B29C 45/4005; B29C 45/561; B29L 2031/34

(57) ABSTRACT

A molding apparatus is proposed for manufacturing a molded component. The molding apparatus may include an upper half mold and a lower half mold cooperatively coupled with each other. A mold cavity is defined between the upper half mold and the lower half mold. The molding apparatus further includes one or more compressing channels formed in the lower half mold and in fluid communication with the mold cavity; and one or more compressing rods, wherein each of the one or more compressing rods is slidably received in a respective one of the one or more compressing channels, wherein a top surface of each of the one or more compressing rods defines a compressing recess within the respective one of the one or more compressing channels.

### BACKGROUND

Injection molding techniques are one of the most commonly used manufacturing processes for the mass manufacturing of components and can use a variety of materials. The injection molding process involves injecting molten materials into a mold cavity formed in a molding apparatus, allowing the molten materials to cool and solidify in the mold cavity. Then the solidified material may be removed from the cavity. Most parts of the computer peripheral devices, such as the cases of the computer peripheral devices, are made of plastic materials. It makes the injection molding technique one of the most cost-effective manufacturing processes for mass manufacturing cases of computer peripheral devices. Usually, the cases of the computer peripheral devices include thin walls. Generally, the thin walls of the cases that are manufactured by injection molding may warp due to unevenly distributed molten material in the mold cavity solidifying unevenly. To alleviate the warpage, during injection molding of the cases with thin walls, the pressure in the mold cavity should be maintained at a certain level to make the molten material solidify under pressure, in order to make sure the molten material fills up every corner of the mold cavity and the density of the molten material remain uniform in the mold cavity. Conventional approaches for pressuring the mold cavity adopt pressurized gases injected into the mold cavity, which causes gas bubbles to be entrapped in the solidified material. There is a great need in the industry to identify new designs for injection molding techniques to alleviate warpage.

### BRIEF SUMMARY

Some embodiments of the present disclosure provide a molding apparatus that may reduce the warpage occurred on the molded component using the molding apparatus. In some cases, some embodiments may be configured to mold components for a computer peripheral device (e.g., a computer mouse, presenter device, keyboard, and the like). In some embodiments, the molding apparatus may include an upper half mold; a lower half mold cooperatively coupled with the upper half mold, wherein a mold cavity is defined between the upper half mold and the lower half mold, wherein the mold cavity is enclosed by a first lateral surface formed in the lower half mold, a side wall formed in the lower half mold, and a second lateral surface formed in the upper half mold. The molding apparatus further includes one or more compressing channels formed in the lower half mold and in fluid communication with the mold cavity via the first lateral surface; and one or more compressing rods, wherein each of the one or more compressing rods is slidably received in a respective one of the one or more compressing channels, wherein a top surface of each of the one or more compressing rods defines a compressing recess within the respective one of the one or more compressing channels.

In some embodiments, the lower half mold comprises an injection passage formed at a first end of the mold cavity, wherein the one or more compressing channels are formed at a second end of the mold cavity opposite the first end.

In some embodiments, the one or more compressing channels comprise a first compressing channel and a second compressing channel, wherein the first compressing channel and the second compressing channel are symmetrically located about a longitudinal axis of the mold cavity.

In some embodiments, the first lateral surface of the lower half mold further comprises a section wall at least partially extending in the mold cavity along the longitudinal axis of the mold cavity to separate the mold cavity into a first part and a second part, wherein the first compressing channel is formed at the first part and the second compressing channel is formed at the second part.

In some embodiments, the section wall further comprises a widened section. wherein the one or more compressing channels are formed adjacent to a peripheral edge of the first lateral surface of the lower half mold.

In some embodiments, a volume of the compressing recess is determined based on a volume of the mold cavity.

In some embodiments, the molding apparatus further comprises an actuatable driving assembly coupled with the one or more compressing rods for driving the one or more compressing rods to reduce a volume of the compressing recess.

In some embodiments, the molding apparatus further comprises: one or more pushing channels formed in the lower half mold, wherein each of the pushing channels is in fluid communication with the mold cavity via the first lateral surface; and one or more pushing rods, wherein each of the one or more pushing rods is slidably received within a respective one of the one or more pushing channels.

In some embodiments, a cross section of each of the one or more compressing channels comprises a circular shape or a rectangular shape.

Other aspects of the present disclosure propose a method of manufacturing a molded component(s) (e.g., for a computer peripheral device, keyboard, presenter device, or the like) using the molding apparatus according to some embodiments of the present disclosure. The method may include providing a molding apparatus, wherein the mold apparatus comprises: an upper half mold; a lower half mold cooperatively coupled with the upper half mold, wherein a mold cavity is defined between the upper half mold and the lower half mold, wherein the mold cavity is enclosed by a first lateral surface formed in the lower half mold, a side wall formed in the lower half mold and a second lateral surface formed in the upper half mold; one or more compressing channels formed in the lower half mold and in fluid communication with the mold cavity via the first lateral surface; and one or more compressing rods, wherein each of the one or more compressing rod is slidably received in a respective one of the one or more compressing channels, wherein a top surface of each of the one or more compressing rods defines a compressing recess within the respective one of the one or more compressing channels; injecting a molten material in the mold cavity and the compressing recess; actuating the one or more compressing rods with a driving force to push the molten material received in the compressing recess back into the mold cavity; maintaining a pressure on the molten material in the mold cavity by maintaining the driving force applied on the one or more compressing rods; solidifying the molten material in the mold cavity for a predetermined time; and removing the solidified molten material from the mold cavity.

Numerous benefits could be provided by the embodiments of the present disclosure. For example, by pushing the molten material received in the compression recess back into the mold cavity during injection molding process, the molten material in the mold cavity may solidify under pressure. Thus, the edge part of the molded component does not warp. In addition, the compressing recess may be provided in the mold cavity at any appropriate place that may easily occur warpage. Thus, the warpage that may occur on the molded component may be effectively controlled. These and other benefits of the present disclosure may be apparent upon reading the specification and the appended claims.

### BRIEF DESCRIPTION OF THE DRAWINGS

The features of the various embodiments described above, as well as other features and advantages of certain embodiments of the present invention will be more apparent from the following detailed description taken in conjunction with the accompanying drawings, in which:

FIG. 1 shows a schematic diagram of a molding apparatus, according to some embodiments of the present disclosure;

FIG. 2 shows a perspective view of a lower half mold and a molded component manufactured using the molding apparatus, according to some embodiments of the present disclosure;

FIG. 3 shows a cross-sectional view of the lower half mold along the line A-A shown in FIG. 2, according to some embodiments of the present disclosure;

FIG. 4 shows a cross-sectional view of the lower half mold along the line A-A shown in FIG. 2, according to some embodiments of the present disclosure;

FIG. 5A-5E shows the molded components manufactured using traditional injection molding apparatus and the molding apparatus according to some embodiments of the present disclosure, wherein FIG. 5A shows a simulated 3D model of the molded component manufactured using the traditional molding apparatus; FIG. 5B shows a side view of a molded component manufactured using the traditional molding apparatus; FIG. 5C shows an enlarged portion B of the molded component shown in FIG. 5B to illustrate the warpage of the molded component; FIG. 5D shows a front view of the molded component manufactured using the traditional molding apparatus to illustrate the warpage of the molded component; and FIG. 5E shows a molded component manufactured using the molding apparatus, according to some embodiments of the present disclosure; and

FIG. 6 shows a flow chart of method of manufacturing a molded component, according to some embodiments of the present disclosure.

Throughout the drawings, it should be noted that like reference numbers are typically used to depict the same or similar elements, features, and structures.

### DETAILED DESCRIPTION

The present disclosure generally relates to computer peripheral devices. In particular, the present disclosure relates to injecting mold for manufacturing computer peripheral devices.

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Generally, for manufacturing a component by injection molding, a molten material is injected into a mold cavity formed in a molding apparatus, and is then removed upon solidification. The molding apparatus usually includes two half molds, for example, an upper half mold and a lower half mold. The mold cavity is defined between the upper half mold and the lower half mold. To facilitate removal of the solidified component from the mold cavity, the molding apparatus usually includes multiple push rods slidably received in respective pushing channels formed in one of the upper half mold and the lower half mold. After the molten material is solidified in the mold cavity, and the upper and lower half molds are separated, the push rods may be actuated to push the solidified component out of the mold cavity.

Some embodiments of the present disclosure provide an injection molding apparatus that includes a compressing recess with a variable volume in fluid communication with the mold cavity. The compressing recess may be formed within a compressing channel between the top surface of the compressing rod and the bottom surface of the mold cavity. During injection molding, the molten material fills up the mold cavity and the compressing recess. After the material injection process ends, the compressing rod may be actuated to reduce the volume of the compressing recess, hence pushing the molten materials in the compressing recess back into the mold cavity and pressurizing the molten material in the mold cavity. Thus, the molten material in the mold cavity may solidify under pressure, and the warpage of the solidified component may be alleviated.

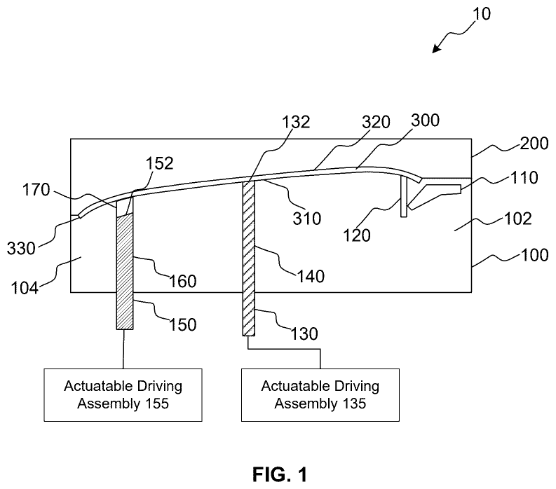

FIG. 1 shows a schematic diagram of a molding apparatus according to some embodiments of the present disclosure. As illustrated, the molding apparatus 10 may include a lower half mold 100 and an upper half mold 200 cooperatively coupled with each other. In some embodiments, the lower half mold 100 and the upper half mold 200 may define a mold cavity 300 therebetween. The mold cavity 300 defines the outer contour of the molded component, such as an upper case of a mouse. In some embodiments, the mold cavity 300 may include a first lateral surface 310 formed in the lower half mold 100, a second lateral surface 320 formed in the upper half mold 200, and a side wall 330 between the first lateral surface 310 and the second lateral surface 320. In the embodiment shown in FIG. 1, the side wall 330 is peripherally formed in the lower half mold 100 around the boundary of the first lateral surface 310. However, it should be noted that the side wall 330 is not required to be formed entirely in the lower half mold 100. In some other embodiments not shown, the side wall 330 may include an upper side wall section formed in the upper half mold 200 and a lower side wall section formed in the lower half mold 100. When the lower half mold 100 and the upper half mold 200 are coupled with each other, the upper side wall section and the lower side wall section may be coupled with each other to form the side wall 330.

As illustrated in FIG. 1, the molding apparatus 10 may include an injection passage 110 formed at a first end 102 of the lower half mold 100, adjacent to the top of the lower half mold 100. In addition, the lower half mold 100 may include a connection passage 120 formed at the first end 102 thereof. The connection passage 120 is in fluid communication with the injection passage 110 and the mold cavity 300. During the molding process, the molten material may be introduced into the mold cavity 300 by way of the injection passage 110 and the connection passage 120. In some embodiments, the lower half mold 100 may include one or more injections passages 110, and one or more connection passages 120. In some embodiments, each injection passage 110 is communicated with one connection passage 120. In some embodiments, one injection passage 110 may be configured to be in fluid communication with multiple connection passages 120 to facilitate the quick injection of molten material into the mold cavity 300.

To facilitate the removal of the molded component from the mold cavity 300, the lower half mold 100 may include one or more push rods 130 slidably received within a respective pushing channel 140 formed in the lower half mold 100. In some embodiments, a top surface 132 of the pushing rod 130 is flush with the first lateral surface 310 of the mold cavity 300. In some embodiments, the molding apparatus 10 may include an actuatable driving assembly 135, such as a motor, coupled with each of the pushing rods 130. During the molding process, after the molten material solidifies in the mold cavity 300, the actuatable driving assembly 135 may be driven to apply a driving force on the pushing rod 130 to raise the pushing rod 130 and push the molded component out of the mold cavity 300.

Usually, the molded component may include small thickness compared with its length and/or width. As illustrated in FIG. 1, the dimension of the side wall 330 is significantly smaller than that of the length of the first lateral surface 310 or the second lateral surface 320. During the molding process, the molten material in the thinner part of the mold cavity 300 solidifies more quickly compared with other parts of the mold cavity 300. Additionally, the distant part of the mold cavity 300 solidifies more quickly than the part close to the injection passage 110. Due to the uneven solidification, the thinner part of the molded component may shrink and warp. Especially the warpage is worse in the distant part of the molded component, away from the injection passage 110.

To alleviate the warpage of the molded component, in some embodiments, the lower half mold 100 may include one or more compressing rods 150 slidably received within a respective compressing channel 160 formed in the lower half mold 100 that is in fluid communication with the mold cavity 300 via the first lateral surface 310. In some embodiments, the compressing channel 160 is formed at the second end 104 of the lower half mold 100 opposite the first end 102. In some embodiments, the compressing rod 150 is structurally like the pushing rod 130, with the difference between the two in that a top surface 152 of the compressing rod 150 is not flush with the first lateral surface 310 of the mold cavity 300. On the contrary, a compressing recess 170 is formed in the compressing channel 160. In some embodiments, the compressing recess 170 is defined by the top surface 152 of the compressing rod 150 and the compressing channel 160. In some embodiments, the compressing recess 170 may include a variable volume that may be adjusted according to particular applications. For example, the volume of the compressing recess 170 could be adjusted by changing the position of the compressing rod 150 within the compressing channel 160. As another example, the volume of the compressing recess 170 could be adjusted by changing the cross-sectional area of the compressing rod 150 and that of the compressing channel 160. In some embodiments, the cross section of the compressing channel 160 may include a circular shape or a rectangular shape.

In some embodiments, the molding apparatus 10 may include an actuatable driving assembly 155, such as a motor, that is coupled with the one or more compressing rods 150. Upon driving of the actuatable driving assembly 155, a driving force is applied on each of the compressing rods 150 to raise the compressing rods 150 to reduce the volume of the compressing recess 170. For example, during the molding process, molten material is injected into the mold cavity 300 and the compressing recess 170. After the injection process is completed, the actuatable driving assembly 155 may be driven to apply a driving force on the compressing rod 150 to reduce the volume of the compressing recess 170, hence compressing the molten material received in the compressing recess 170 back into the mold cavity 300. Thus, the molten material in the mold cavity 300 is compressed to a certain level and can solidify under pressure. Due to the pressure produced by the extra volume of molten material received in the compressing recess 170, the warpage of the molded component may be efficiently reduced.

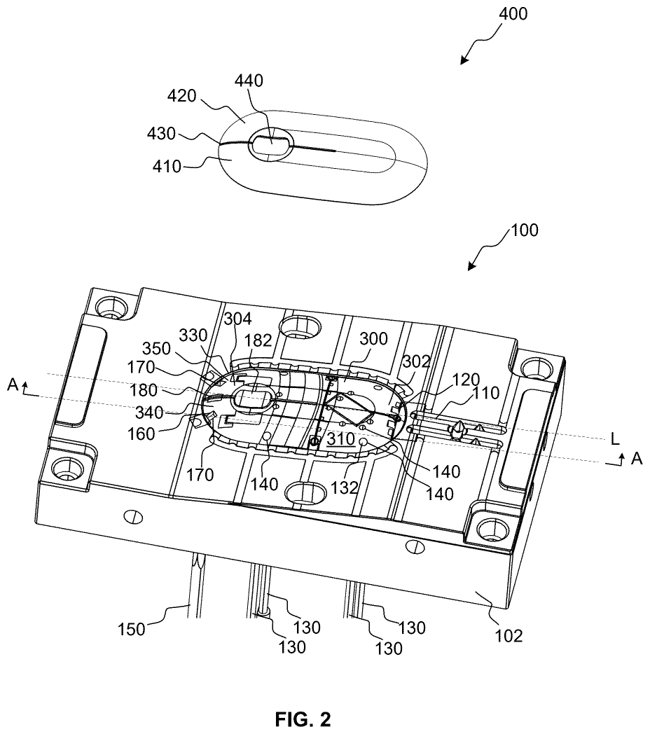

FIG. 2 shows a perspective view of a lower half mold 100 and a molded component 400 manufactured using the molding apparatus 10 according to some embodiments of the present disclosure. As illustrated, the molded component 400 represents the upper case of a mouse. As illustrated, the lower half mold 100 partially defines the mold cavity 300. As described above with reference to FIG. 1, the mold cavity 300 may include the first lateral surface 310 and the side wall 330 around the first lateral surface 310. It should be noted that the lower half mold 100 could be used to manufacture the upper case of a mouse, as shown by the molded component 400 in FIG. 2. However, the present disclosure is not limited to the specific shape of the molded component 400 illustrated in FIG. 2. As illustrated in FIG. 2, the lower half mold 100 may include the injection passage 110 formed at the first end 102 of the lower half mold 100. In other word, the injection passage 110 is formed at the first end 302 of the mold cavity 300. In the embodiments shown in FIG. 2, there are two injection passages 110 extending parallel with each other. Each of the injection passages 110 is in fluid communication with the connection passage 120 formed at the first end 302 of the mold cavity 300. As shown in FIG. 2, the connection passage 120 is formed as a slot extending traverse the mold cavity 300. The slot shape of the connection passage 120 may facilitate the quick injection of the molten material into the mold cavity 300.

As shown in FIG. 2, the lower half mold 100 may include multiple push rods 130 slidably each received within a respective pushing channel 140 formed in the lower half mold 100. For clarity of illustration, some pushing rods 130 have been omitted from the lower half mold 100 shown in FIG. 2. In some embodiments, the top surface 132 of the pushing rod 130 is flush with the first lateral surface 310 of the mold cavity 300. In some embodiments, the molding apparatus 10 may include the actuatable driving assembly 135 (shown in FIG. 1), such as a motor, coupled with each of the pushing rods 130. During the molding process, after the molten material solidifies in the mold cavity 300, the actuatable driving assembly 135 may be driven to raise the pushing rods 130 and push the molded component 400 out of the mold cavity 300.

As shown in FIG. 2, the lower half mold 100 may include two compressing rods 150 each slidably received within a respective compressing channel 160 formed in the lower half mold 100 that is in fluid communication with the mold cavity 300 via the first lateral surface 310. In some embodiments, the two compressing channel 160 are symmetrically located about a longitudinal axis L of the mold cavity 300. As shown in FIG. 2, the compressing recess 170 is formed in the compressing channel 160 and is defined by the top surface 152 of the compressing rod 150 and the compressing channel 160. In some embodiments, the molding apparatus 10 may include the actuatable driving assembly 155 (shown in FIG. 1), such as a motor, that is coupled with the compressing rod 150. Upon driving of the actuatable driving assembly 155, the compressing rod 150 may be raised to reduce the volume of the compressing recess 170. As shown in FIG. 2, the cross section of the compressing channel 160 includes a rectangular shape.

As shown in FIG. 2, the lower half mold 100 may include a section wall 180 at least partially extending in the mold cavity 300 along the longitudinal axis L of the mold cavity 300 to separate the mold cavity into a first part 340 and a second part 350. The first part 340 may be used to form the left button 410 of the molded component 400 and the second part 350 may be used to form the right button 420 of the molded component 400. Due to the section wall 180, a gap 430 is formed between the left button 410 and the right button 420. In addition, the section wall 180 may also include a widened section 182. Due to the widened section 182, the molded component 400 may include a void space 440, which may be used to accommodate a roller for the mouse.

In the embodiment shown in FIG. 2, the left button 410 and the right button 420 of the molded component 400 could be referred as the free ends of the molded component 400. It has been observed that the warpage occurs more frequently at the free ends of the molded component 400. Thus, as shown in FIG. 2, the compressing recess 170 is provided adjacent to the first part 340 and the second part 350. In other words, the lower half mold 100 includes two compressing channels 160, one of which is provided at the first part 340, and the other of which is provided at the second part 350. As shown in FIG. 2, the connection passage 120 is provided at the first end 302 of the mold cavity 300. Thus, the molten materials injected in the mold cavity 300 may solidify quickly at the second end 304 of the mold cavity 300 opposite the first end 302. Hence warpage occurs easier at the second end 304 of the mold cavity 300. In some embodiments, the compressing recess 170 is provided adjacent to the second end 304 of the mold cavity 300. In other words, the compressing recess 170 is formed close to the distant edge of the first lateral surface 310 of the mold cavity 300, opposite the injection passage 110. It should be noted that although the compressing recess 170 is provided adjacent to the distal end of the mold cavity 300, as shown in FIG. 2, the present disclosure is not limited to the specific location of the compressing recess 170. In some other embodiments, the compressing recess 170 may be provided in the mold cavity 300 at any appropriate places where the molded component may occur warpage.

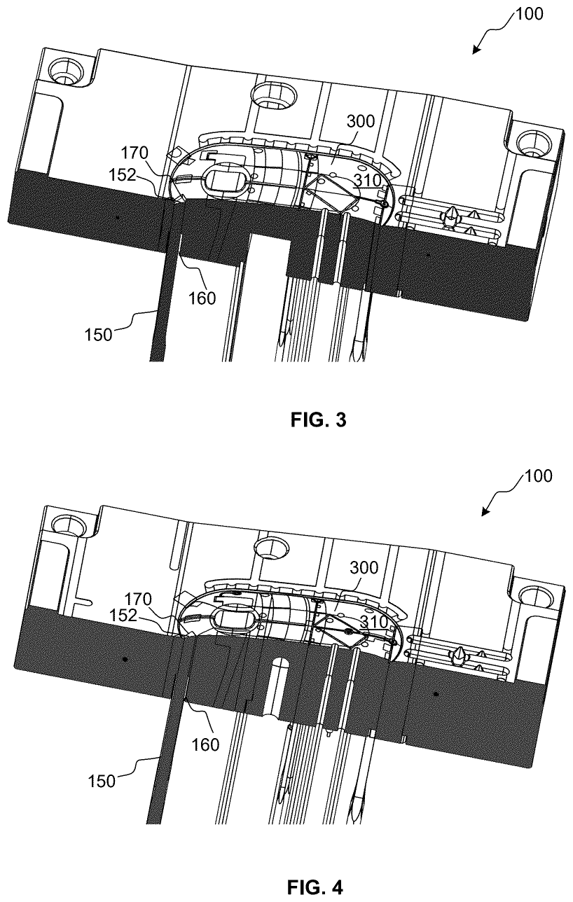

FIG. 3 shows a cross-sectional view of the lower half mold 100 along the line A-A shown in FIG. 2 according to some embodiments of the present disclosure. For clarity of illustration, some pushing rods 130 have been omitted from FIG. 3. As illustrated, the compressing channel 160 is formed through the lower half mold 100 and is in fluid communication with mold cavity 300 via the first lateral surface 310. The compressing rod 150 is slidably received in the compressing channel 160. The top surface 152 of the compressing rod 150 defines the compressing recess 170 within the compressing channel 160. It should be noted that FIG. 3 shows the initial position of the compressing rod 150 within the compressing channel 160 before injecting the molten material in the mold cavity 300. The molding apparatus 10 may include the actuatable driving assembly 155 (shown in FIG. 1), such as a motor, that is coupled with the compressing rod 150. Upon driving the actuatable driving assembly 155, the compressing rod 150 may be raised to reduce the volume of the compressing recess 170 until the top surface 152 of the compressing rod 150 is flush with the first lateral surface 310 of the mold cavity 300. Thus, the molten material received in the compressing recess 170 is pushed back into the mold cavity 300 to locally compress the molten material around the compressing recess 170. In this way, the molten material around the compressing recess 170 may solidify under pressure, alleviating warpage that may occur at the molded component around the compressing recess 170.

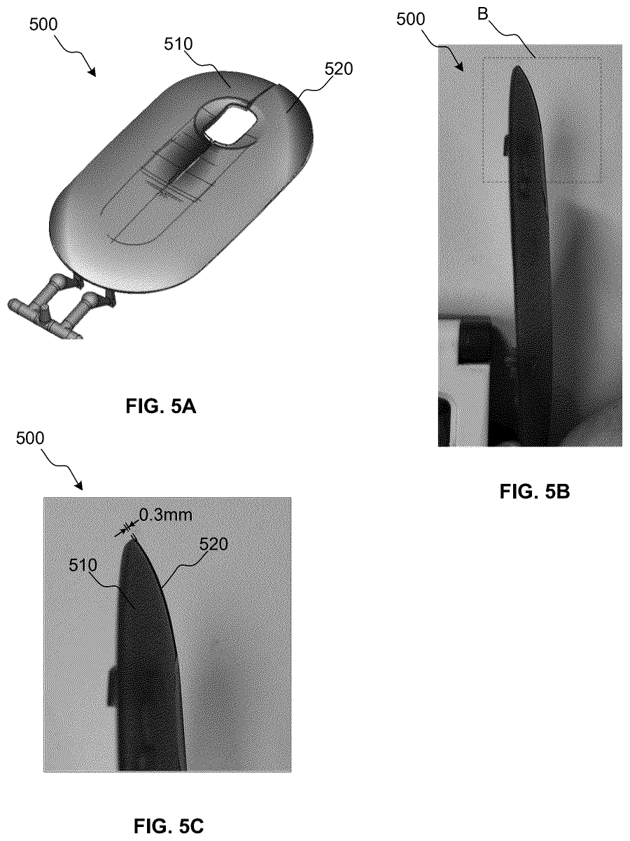

FIG. 4 shows a cross-sectional view of the lower half mold 100 along the line A-A shown in FIG. 2 according to some embodiments of the present disclosure. For clarity of illustration, some pushing rods 130 have been omitted from FIG. 4. It should be noted that FIG. 4 shows the compressing position of the compressing rod 150 within the compressing channel 160 after the molten material is injected in the mold cavity 300. As shown in FIG. 4, the compressing rod 150 has been driven by the actuatable driving assembly 155 to raise within the compressing channel 160 until the top surface 152 of the compressing rod 150 is flush with the first lateral surface 310 of the mold cavity 300. The volume of the compressing recess 170 has been reduced to zero and the molten material received in the compressing recess 170 has been pushed back into the mold cavity 300 to compress the molten material in the mold cavity 300.

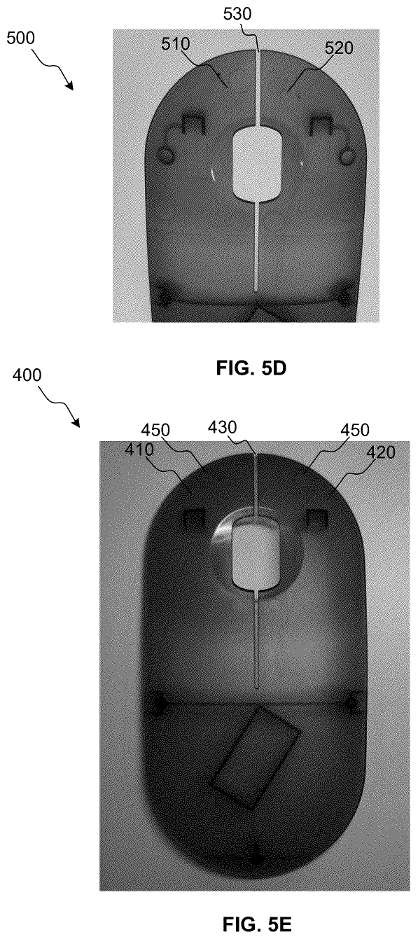

FIG. 5A-5E shows the molded components manufactured using traditional injection molding apparatus and the molding apparatus according to some embodiments of the present disclosure, wherein FIG. 5A shows a simulated 3D model of the molded component manufactured using the traditional molding apparatus, FIG. 5B shows a side view of a molded component manufactured using the traditional molding apparatus, FIG. 5C shows an enlarged portion B of the molded component shown in FIG. 5B to illustrate the warpage of the molded component, FIG. 5D shows a front view of the molded component manufactured using the traditional molding apparatus to illustrate the warpage of the molded component, and FIG. 5E shows a molded component manufactured using the molding apparatus according to some embodiments of the present disclosure.

As shown in FIG. 5A, the molded component 500 manufactured using traditional molding apparatus illustrates an upper case of a mouse. As illustrated, due to the uneven solidification of molten material, the left button 510 and the right button 520 warp after solidification, and do not align with each other. In some cases, the inventors observed 0.3 mm mismatch between the left button 510 and the right button 520, as shown in FIG. 5C.

As shown in FIG. 5D, due to the warpage occurred at the left button 510 and the right button 520, the gap 530 between the left button 510 and the right button 520 is not uniform along the entire length of the gap 530. As illustrated, the upper portion of the gap 530 between the left button 510 and the right button 520 is wider than the lower portion of the gap 530.

As shown in FIG. 5E, the molded component 400 is manufactured using molding apparatus 10 according to some embodiments of the present disclosure. The compressing mark 450 on each of the left button 410 and the right button 420 is produced by the compressing rod 150. Due the compressing effect produced by the molten material received in the compressing recess 170 (shown in FIGS. 3 and 4), the left button 410 and the right button 420 do not warp. Thus, the left button 410 and the right button 420 align with each other without mismatch, and the width of the gap 430 between the left button 410 and the right button 420 remains uniform along its entire length.

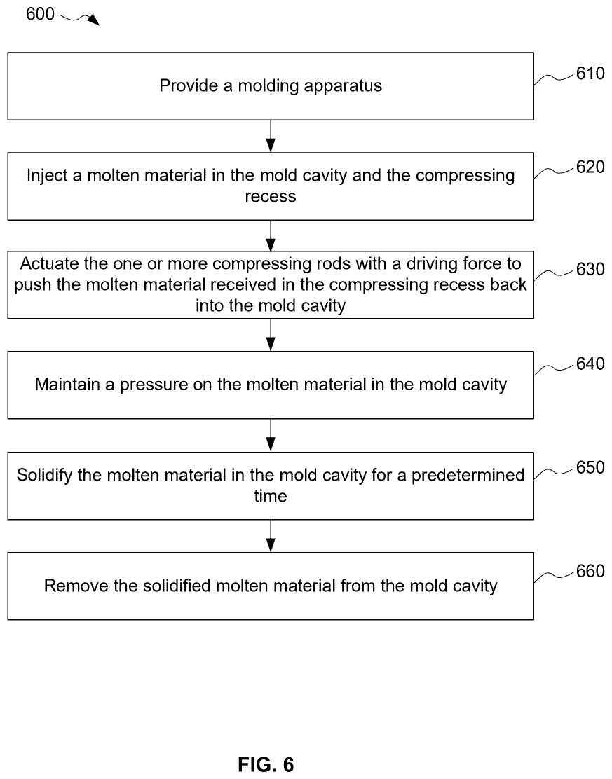

Another aspect of the present disclosure proposes a method of manufacturing molded component using the molding apparatus according to some embodiments of the present disclosure. FIG. 6 shows a flow chart of method 600 of manufacturing a molded component according to some embodiments of the present disclosure. It should be noted that method 600 is performed using molding apparatus 10 according to some embodiments of the present disclosure. Thus, the above description with reference to FIGS. 1-4 about the molding apparatus 10 applies to the method 600. In some embodiments, the method 600 may include, at step 610, providing the molding apparatus 10 according to some embodiments of the present disclosure. As described above, the molding apparatus 10 may include a lower half mold 100 and an upper half mold 200 cooperatively coupled with each other. In some embodiments, the lower half mold 100 and the upper half mold 200 may define a mold cavity 300 therebetween. The mold cavity 300 defines the outer contour of the molded component, such as the upper case of a mouse. In some embodiments, the mold cavity 300 may include the first lateral surface 310 formed in the lower half mold 100, a second lateral surface 320 formed in the upper half mold 200, and a side wall 330 between the first lateral surface 310 and the second lateral surface 320. In other words, the mold cavity 300 is enclosed by the first lateral surface 310, the second lateral surface 320, and the side wall 330. In the embodiment shown in FIG. 1, the side wall 330 is peripherally formed in the lower half mold 100 around the boundary of the first lateral surface 310.

In some embodiments, the lower half mold 100 may include one or more compressing rods 150 each slidably received within a respective compressing channel 160 formed in the lower half mold 100 that is in fluid communication with the mold cavity 300 via the first lateral surface 310. In some embodiments, the compressing recess 170 is formed in the compressing channel 160. In some embodiments, the compressing recess 170 is defined by the top surface 152 of the compressing rod 150 and the compressing channel 160. In some embodiments, the compressing recess 170 may include a variable volume that may be adjusted according to particular applications.

In some embodiments, the method 600 may include, at step 620, injecting a molten material in the mold cavity 300 and the compressing recess 170. As illustrated in FIG. 1, the molding apparatus 10 may include the injection passage 110 formed at the first end 102 of the lower half mold 100, adjacent to the top of the lower half mold 100. In addition, the lower half mold 100 may include the connection passage 120 formed at the first end 102 thereof. The connection passage 120 is in fluid communication with the injection passage 110 and the mold cavity 300. During the molding process, the molten material may be introduced into the mold cavity 300 by way of the injection passage 110 and the connection passage 120. In some embodiments, the molten material may include Acrylonitrile Butadiene Styrene (ABS), Polycarbonate (PC), and Thermoplastic Polyurethane (TPU), etc.

In some embodiments, the method 600 may include, at step 630, actuating the one or more compressing rods 150 with a driving force to push the molten material received in the compressing recess 170 back into the mold cavity 300. As shown in FIG. 1, the molding apparatus 10 may include the actuatable driving assembly 155, such as a motor, that is coupled with the compressing rod 150. Upon driving of the actuatable driving assembly 155, a driving force is applied on the compressing rod 150 to raise the compressing rod 150 to reduce the volume of the compressing recess 170, hence compressing the molten material received in the compressing recess 170 back into the mold cavity 300.

Then, the method 600 may include, at step 640, maintaining a pressure on the molten material in the mold cavity 300 by maintaining the driving force applied on the one or more compressing rods 150. After the molten material received in the compressing recess 170 is pushed back to the mold cavity 300, the driving force applied by the actuatable driving assembly 155 may be maintained for a predetermined time. In this way, the molten material in the mold cavity 300 may solidify under pressure, alleviating warpage that may occur at the molded component around the compressing recess 170.

Next, the method 600 may include, at step 650, solidifying the molten material in the mold cavity 300 for a predetermined time. In some embodiments, the predetermined time may be determined based on the volume of the molten material in the mold cavity 300 to make sure the molten material sufficiently solidifies.

Finally, the method 600 may include, at step 660, removing the solidified molten material from the mold cavity 300. In some embodiments, the lower half mold 100 and the upper half mold 200 may be separated for removing the solidified molten material from the mold cavity 300. In some embodiments, to facilitate the removal of the molded component from the mold cavity 300, the lower half mold 100 may include one or more push rods 130 each slidably received within a respective pushing channel 140 formed in the lower half mold 100. In some embodiments, the molding apparatus 10 may include the actuatable driving assembly 135, such as a motor, coupled with each of the pushing rods 130. During the molding process, after the molten material solidifies in the mold cavity 300, the actuatable driving assembly 135 may be driven to apply a driving force on the pushing rod 130 to raise the pushing rod 130 and separate the solidified molten material from the mold cavity 300.

It should be noted that the systems and devices discussed above are intended merely to be examples. It must be stressed that various embodiments may omit, substitute, or add various procedures or components as appropriate. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known structures and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

What is claimed is:

1. A molding apparatus for a molding a component of a computer peripheral device, comprising:
an upper half mold;
a lower half mold cooperatively coupled with the upper half mold, wherein a mold cavity is defined between the upper half mold and the lower half mold, wherein the mold cavity is enclosed by a first lateral surface formed in the lower half mold, a side wall formed in the lower half mold, and a second lateral surface formed in the upper half mold;
one or more compressing channels formed in the lower half mold and in fluid communication with the mold cavity via the first lateral surface; and
one or more compressing rods, wherein each of the one or more compressing rods is slidably received in a respective one of the one or more compressing channels, wherein a top surface of each of the one or more compressing rods defines a compressing recess within the respective one of the one or more compressing channels.

2. The molding apparatus of claim 1, wherein the lower half mold comprises an injection passage formed at a first end of the mold cavity, wherein the one or more compressing channels are formed at a second end of the mold cavity opposite the first end.

3. The molding apparatus of claim 1, wherein the one or more compressing channels comprise a first compressing channel and a second compressing channel, wherein the first compressing channel and the second compressing channel are symmetrically located about a longitudinal axis of the mold cavity.

4. The molding apparatus of claim 3, wherein the first lateral surface of the lower half mold further comprises a section wall at least partially extending in the mold cavity along the longitudinal axis of the mold cavity to separate the mold cavity into a first part and a second part, wherein the first compressing channel is formed at the first part and the second compressing channel is formed at the second part.

5. The molding apparatus of claim 4, wherein the section wall further comprises a widened section.

6. The molding apparatus of claim 1, wherein the one or more compressing channels are formed adjacent to a peripheral edge of the first lateral surface of the lower half mold.

7. The molding apparatus of claim 1, wherein a volume of the compressing recess is determined based on a volume of the mold cavity.

8. The molding apparatus of claim 1, further comprises an actuatable driving assembly coupled with the one or more compressing rods for driving the one or more compressing rods to reduce a volume of the compressing recess.

9. The molding apparatus of claim 1, further comprises:
one or more pushing channels formed in the lower half mold, wherein each of the pushing channels is in fluid communication with the mold cavity via the first lateral surface; and
one or more pushing rods, wherein each of the one or more pushing rods is slidably received within a respective one of the one or more pushing channels.

10. The molding apparatus of claim 1, wherein a cross section of each of the one or more compressing channels comprises a circular shape or a rectangular shape.

11. A method for manufacturing a molded component of a computer peripheral device, the method comprising:
providing a molding apparatus, wherein the mold apparatus comprises:
an upper half mold;
a lower half mold cooperatively coupled with the upper half mold, wherein a mold cavity is defined between the upper half mold and the lower half mold, wherein the mold cavity is enclosed by a first lateral surface formed in the lower half mold, a side wall formed in the lower half mold and a second lateral surface formed in the upper half mold;
one or more compressing channels formed in the lower half mold and in fluid communication with the mold cavity via the first lateral surface; and
one or more compressing rods, wherein each of the one or more compressing rod is slidably received in a respective one of the one or more compressing channels, wherein a top surface of each of the one or more compressing rods defines a compressing recess within the respective one of the one or more compressing channels;
injecting a molten material in the mold cavity and the compressing recess;
actuating the one or more compressing rods with a driving force to push the molten material received in the compressing recess back into the mold cavity;
maintaining a pressure on the molten material in the mold cavity by maintaining the driving force applied on the one or more compressing rods;
solidifying the molten material in the mold cavity for a predetermined time; and
removing the solidified molten material from the mold cavity.

12. The method of claim 11, wherein the lower half mold comprises an injection passage formed at a first end of the mold cavity, wherein the one or more compressing channels are formed at a second end of the mold cavity opposite the first end.

13. The method of claim 11, wherein the one or more compressing channels comprises a first compressing channel and a second compressing channel, wherein the first compressing channel and the second compressing channel are symmetrically located about a longitudinal axis of the mold cavity.

14. The method of claim 13, wherein the first lateral surface of the lower half mold further comprises a section wall at least partially extending in the mold cavity along the longitudinal axis of the mold cavity to separate the mold cavity into a first part and a second part, wherein the first compressing channel is formed at the first part and the second compressing channel is formed at the second part.

15. The method of claim 14, wherein the section wall further comprises a widened section.

16. The method of claim 11, wherein the one or more compressing channels are formed adjacent to a peripheral edge of the first lateral surface of the lower half mold.

17. The method of claim 11, wherein a volume of the compressing recess is determined based on a volume of the mold cavity.

18. The method of claim 11, further comprises an actuatable driving assembly coupled with the one or more compressing rods, wherein the method further comprises:
actuating the actuatable driving assembly to apply the driving force on the one or more compressing rods to reduce a volume of the compressing recess.

19. The method of claim 11, wherein the molding apparatus further comprises:
one or more pushing channels formed in the lower half mold, wherein each of the pushing channels is in fluid communication with the mold cavity via the first lateral surface; and
one or more pushing rods, wherein each of the one or more pushing rods is slidably received within a respective one of the one or more pushing channels,
the method further comprises:
driving the one or more pushing rods to separate the solidified molten material from the mold cavity.

20. The method of claim 11, wherein a cross section of each of the one or more compressing channels comprises a circular shape or a rectangular shape.
